(19) United States
(12) Patent Application Publication
(10) Pub. No.: US 2006/0268760 A1
(43) Pub. Date: Nov. 30, 2006

(54) Medium access control in wireless local area networks with multi-beam access point

(75) Inventors: Yuguang M. Fang, Gainesville, FL (US); Jianfeng Wang, Gainesville, FL (US); Dapeng Oliver Wu, Gainesville, FL (US)

Correspondence Address: AKERMAN SENTERFITT, P.O. BOX 3188, WEST PALM BEACH, FL, 33402-3188, US

(73) Assignee: UNIVERSITY OF FLORIDA RESEARCH FOUNDATION, INC., GAINESVILLE, FL (US)

(21) Appl. No.: 11/131,103

(22) Filed: May 17, 2005

(51) Int. Cl. H04Q 7/00

(52) U.S. Cl. 370/328

(57) ABSTRACT

A method for conveying digitally encoded data within a Wireless Local Area Network (WLAN) using a contention based Media Access Control (MAC) protocol. In the method, a multi-beam access point can transmit a channel contention request and responsively receive channel contention responses. A set of nodes can be determined based upon the channel contention responses. Each node of the determined set can be assigned one beam of the multi-beam access point. The nodes can use the assigned beams to simultaneously communicate with said multi-beam access point in a collision-free fashion along an assigned beam.

### BACKGROUND

1. Fiel of the Invention

The present invention relates to the field of network communications, and, more particularly, to CSMA/CA based MAC communications involving a multi-beam access point.

2. Description of the Related Art

Internetworking involves connecting two or more computer networks with some variety of routing device to exchange traffic back and forth, and to guide traffic on the correct path across the complete network to their destination. The International Standards Organization (ISO) has developed an Open Systems Interconnection (OSI) reference model to define layers of a computer network architecture. OSI is an abstract model, meaning that actual network implementations need not adhere to it strictly. The OSI layers include: Layer One—Physical; Layer Two—Data Link; Layer Three—Network; Layer Four—Transport; Layer Five—Session; Layer Six—Presentation; and Layer Seven—Application.

The Data Link Layer can be further divided into a Logical Link Control (LLC) sub-layer and Media Access Control (MAC) sub-layer. The LLC sub-layer provides error-free transfer of data frames from one node to another. The MAC sub-layer manages access to the physical layer, checks frame errors, and manages address recognition of received frames. That is, the MAC sub-layer controls access to physical transmission medium, usually when this access is shared between users, such as in Ethernet, Global System for Mobile Communications (GSM), General Packet Radio Service (GPRS), and other such communications.

MAC mechanisms include Digital Sense Multiple Access(DSMA) and Carrier-Sense Multiple Access (CSMA). In DSMA, access to a shared uplink radio channel is controlled by sensing a digital flag encoded into a received downlink channel before attempting an access. DSMA is used by many mobile devices, which are not capable of detecting each other's transmissions. DSMA is used to control access to multiple uplink channels in protocols like GMS and GPRS.

CSMA is a medium access control technique for multiple access transmission media. In CSMA, a station wishing to transmit first senses the medium (heartbeat) and transmits only if the medium is idle. That is, CSMA is a technique where stations listen to network activity and wait until no carrier is detected before transmitting. For Ethernet communications, CSMA can be combined with collision detection (CD) resulting in Carrier Sense Multiple Access with Collision Detection (CSMA/CD).

The 802.11 family of Wireless Local Area Network (WLAN) protocols utilize CSMA/CD methodologies for data conveyance. A WLAN can include an access point and one or more computing stations. Conventional access points and stations each include a single omni-directional transceiver. When an entity (station or access point) wishes to transmit information, the entity first “senses the medium”, meaning it determines if a wireless transmission data pathway is available. When the medium is available, the entity transmits data over the medium. When the medium is busy, the entity defers transmission. In this manner, collisions are avoided because each entity is only allowed to transmit data over the medium when no other entity is transmitting information. Unfortunately, the conventional collision avoidance technique only permits one entity to utilize the medium at any one time, which can result in performance lags within a heavily utilized WLANs.

### SUMMARY OF THE INVENTION

The present invention teaches the use of a multi-beam antenna within a Wireless Local Area Network (WLAN) access point, in accordance with embodiments expressed herein. More specifically, the multi-beam access point can utilize a carrier sensing multiple access/collision avoidance (CSMA/CA) based Medium Access Control (MAC) protocol that has been enhanced beyond conventional CSMA/CA protocols to permit simultaneous traffic between WLAN nodes and the multi-beam access point. Conventional CSMA MAC protocols make no effort to orchestrate the spatial re-use of a channel. The multi-beam access point can improve throughput performance of CSMA/CA-based MAC communications by a spatial reuse technique that permits multiple parallel uplink data transmissions and/or multiple parallel downlink data transmissions.

The disclosed invention retains backwards compatibility with legacy equipment, such as IEEE 802.11 based equipment, by permitting computing stations equipped with existing 802.11 wireless communication hardware to communicate with the multi-beam access hub. Collisions are avoided because each computing station exchanges data with the multi-beam hub over a dedicated beam, each beam representing a reserved spatial section of a medium.

The present invention can be implemented in accordance with numerous aspects consistent with material presented herein. For example, one aspect of the present invention can include a method for conveying digitally encoded data within a WLAN using a contention based MAC protocol. In the method, a multi-beam access point can transmit a channel contention request and responsively receive channel contention responses. A set of nodes can be determined based upon the channel contention responses. Each node of the determined set can be assigned one beam of the multi-beam access point. The nodes can use the assigned beams to simultaneously communicate with said multi-beam access point in a collision-free fashion along an assigned beam.

Another aspect of the present invention can include a Wireless Local Area Network (WLAN) comprising one or more computing stations and a multi-beam access point. The computing stations can be communicatively linked via a contention-based, collision free MAC protocol. The multi-beam access point can assign a plurality of beams to particular ones of the computing stations. The computing stations assigned to beams can wirelessly communicate with the multi-beam access point via assigned beams. One or more of the computing stations can use EEE 802.11 compliant hardware to communicate with the multi-beam access point.

Still another aspect of the present invention can include a multi-beam access point configured to operate within an ad hoc WLAN using a contention-based collision free MAC protocol. The multi-beam access point can initiate wireless data conveyances with nodes by transmitting channel contention requests and assigning beams to nodes based upon channel contention responses. The nodes can wirelessly exchange data with said multi-beam access point via the assigned beams.

The multi-beam access point can include a multi-beam smart antenna and at least one transceiver. The multi-beam smart antenna can capture and radiate radio frequency energy within a 2.4 GHz to 2.4835 GHz frequency range and/or within a 5.15 GHz to 5.825 GHz frequency range, which are frequency ranges associated with the 802.11 family of wireless communication protocols. Moreover, the transceivers can be communicatively linked to the multi-beam smart antenna. In particular embodiments, several transceivers can be included within the multi-beam access point and used to simultaneously send and/or receive data along the assigned beams.

Yet another aspect of the present invention can include a time division communication frame for digitally conveying data between nodes in a contention based, collision free Media Access Control (MAC) layer of a WLAN. The communication frame can include a channel contention period, a selection period, a transmission period, and an acknowledgement period. The channel contention period can be an established time within which channel contention requests are transmitted. The selection period can be an established time following the channel contention period. During the selection period, channel contention responses associated with nodes can be received and communication beams can be assigned to nodes. Following the selection period, the transmission period can begin. The transmission period can be an established time within which a plurality of nodes use assigned beams to wirelessly exchange packetized digital data. The nodes can simultaneously exchange data in parallel over different beams. The acknowledgement period can be an established time period following the transmission period in which acknowledgements of successful transmission of data are conveyed in parallel over different beams.

It should be noted that various aspects of the invention can be implemented as a program for controlling computing equipment to implement the functions described herein, or a program for enabling computing equipment to perform processes corresponding to the steps disclosed herein. This program may be provided by storing the program in a magnetic disk, an optical disk, a semiconductor memory, any other recording medium, or can also be provided as a digitally encoded signal conveyed via a carrier wave. The described program can be a single program or can be implemented as multiple subprograms, each of which interact within a single computing device or interact in a distributed fashion across a network space.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram of a system including a multi-beam access point in accordance with an embodiment of the inventive arrangements disclosed herein.

FIG. 2 is a diagram illustrating a multi-beam access point being utilized within a multi-hop wireless local area network in accordance with an embodiment of the inventive arrangements disclosed herein.

FIG. 3 is a flow chart of a method for using a multi-beam access point in accordance with an embodiment of the inventive arrangements disclosed herein.

FIG. 4 is a diagram illustrating communication frames for conveying data within a wireless local area network in accordance with an embodiment of the inventive arrangements disclosed herein.

### DETAILED DESCRIPTION OF THE INVENTION

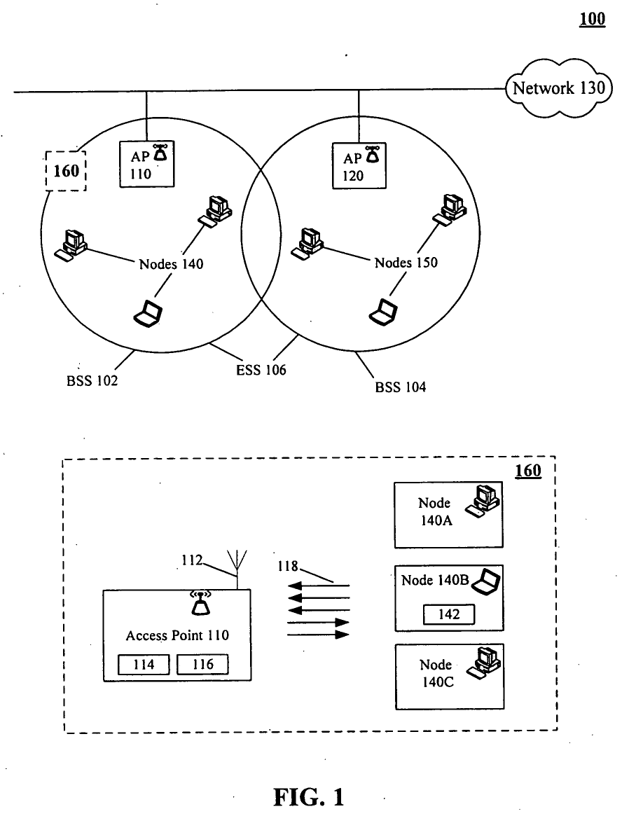

FIG. 1 is a schematic diagram of a system 100 including a multi-beam access point in accordance with an embodiment of the inventive arrangements disclosed herein. System 100 can include basic service set (BSS) 102 and BSS 104 that can be jointed to form extended service set (ESS) 106.

BSS 102 and BSS 104 can consist of a set of wireless devices linked over a wireless medium in a peer-to-peer fashion. BSS 102 can include nodes 140, which are configured to communicate directly with one another. BSS 104 can include nodes 150, which are configured to communicate directly with one another. Nodes 140 can also directly communicate with access point (AP) 110 and nodes 150 can directly communicate with AP 120.

Each of the nodes 140 and 150 can include any variety of computing device configured to remotely exchange data within the WLAN. Thus, each node 140 can represent a communication station, such as a notebook computer, a desktop computer, a personal data assistant, a tablet computer, a server, a mobile telephone, a portable gaming device, a hand held media station, a network-enabled radio, television, or other A/V component, a wearable-computing device, and the like. Each of the nodes can include a wireless transceiver, such as a 802.11 compatible transceiver.

BSS 102 and BSS 104 can be considered an ad-hoc network, where different nodes can be dynamically added and removed from the network. For example, when a new node is brought into the wireless transmission range of BSS 102, the new node can be dynamically added. Additionally, when an existing node 140 is moved outside the range of BSS 102, then that node can be dynamically removed.

In one embodiment, one or more of BSS 102 and BSS 104 can be an infrastructure BSS. In an infrastructure BSS, an access point can provide a local relay function for the BSS, which can effectively double the range of a BSS.

For example, when BSS 102 is an infrastructure BSS, all nodes stations in the BSS can communicate with the AP 110 instead of communicating directly with one another. All frames of digitally encoded data are relayed between nodes 140 by the AP 110.

ESS 106 can include a set of infrastructure BSS's, such as BSS 102 and BSS 104, where access points within the included set of infrastructure BSS's communicate amongst themselves to forward traffic from one BSS to another. For example, in ESS 106, AP 110 and AP 120 can exchange information with each other thereby linking BSS 102 and BSS 104. Notably, network equipment outside ESS 106 can view all nodes 140 and 150 within ESS 106 as a single MAC-layer network where all inclusive computing stations are physically stationary. Thus, ESS 106 hides the mobility of nodes 140 and 150 at the MAC-layer from outside computing device with which nodes 140 and 150 communicate.

Each of AP 110 and 120 can provide a connection to a distribution system, such as network 130. The distribution system can be the backbone of the wireless system and can include any combination of wired and wireless LANs. Accordingly, network 130 can represent any communication mechanism capable of conveying digitally encoded information. Network 130 can, for example, include a telephony network like a public switched telephone network (PSTN) or a mobile telephone network, a computer network such as a local area network or a wide area network, a cable network, a satellite network, a broadcast network, and the like. Since AP 110 is linked to network 130, nodes 140 can communicate with network 130 devices.

Since AP 110 and AP 120 can function as a centralized communication junction for nodes, substantial performance gains can be achieved by increasing the available wireless communication medium for exchanging data with AP 110 and/or AP 120. Towards this end, each or both of AP 110 and AP 120 can be multi-beam access points.

Diagram 160 is a schematic diagram of a configuration wherein AP 110 is a multi-beam access point. In diagram 160, AP 110 can exchange data with a nodes 140A, 140B, and 140C across multiple beams 118.

AP 110 can include multi-beam antenna 112, and one or more transceivers, such as transceiver 114 and 116. Antenna 112 can capture and radiate radio frequency energy within a defined frequency range. In one embodiment, antenna 112 can be configured for the frequency ranges defined by IEEEE for the 802.11 family of wireless protocols. For example, antenna 112 can be configured to operate within the 2.4 GHz to 2.4835 GHz frequency range defined for 802.11b and 802.11g. Antenna 112 can also be configured to operate within the 5.15 GHz to 5.825 GHz frequency range defined for 802.11a.

The invention is not limited in this regard, however, and antenna 112 can be adapted to operate within any frequency range. The 802.11 standardized frequency ranges are preferred operational ranges for configurations where it is desirable that the AP 110 be backwards compatible with conventional single-beam wireless access point standards, and can therefore be implemented without modifying the transceiving equipment of the nodes with which AP 110 wirelessly communicates. For example, node 140B can include transceiving hardware 142, which can be IEEE 802.11 compliant hardware that can be used to communicate with a single-beam access point as well as a multi-beam access point.

Antenna 112 can be a directional antenna specifically implemented as one or more fixed beam-directional antennas or as an adaptive antenna array. It should be appreciated that directional antennas beneficially permit spatial reuse and also provide an antenna gain. The spatial reuse can permit a BSS 102 to be divided into a plurality of geographically bound sectors, each sector aligned with a direction of antenna 112, and each sector representing a particular beam available to the AP 110. Additionally, the antenna gain of a directional antenna can increase the range of the BSS 102 and/or can permit the AP 110 and nodes 140 to operate at a reduced power rate.

In one embodiment where antenna 112 includes fixed beam directional antennas, multiple directional antennas can share a single transceiver. In another embodiment, multiple directional antennas can utilize multiple transceivers, such as transceiver 114 and transceiver 116.

In one arrangement, a one to one correspondence can be established between fixed directional antennas and transceivers. Thus, transceiver 114 can correspond to one fixed directional antenna and transceiver 116 can correspond to another fixed directional transceiver. Accordingly, if five beams or spatial sectors were desired, AP 110 can be designed to include five different fixed direction antennas and five corresponding transceivers. Arrangements where the AP 110 includes multiple transceivers can be beneficial, as these arrangements can permit parallel data conveyances.

The invention is not limited to a one to one correspondence of fixed directional antennas to transceivers, however, and any number of directional antennas can be associated with any number of transceivers. For example, four directional antennas can be utilized to spatially divide a medium into four spatial sections and a two transceivers can be linked to the four directional antennas. One transceiver can be dedicated to receiving information from one of nodes 140A-C and another can be dedicated to receiving information to another of nodes 140A-C; or one transceiver can be dedicated to transmitting information to one of nodes 140A-C and another can be dedicated to transmitting information to another of nodes 140A-C. Thus, the AP 110 can simultaneously transmit or receive data along different beams.

Beams 118 illustrate that information can be uploaded to or downloaded from access point 110. That is, node 140A and node 140B can transmit data to AP 110 simultaneously, or node 140A and node 140B can receive data from AP 110 simultaneously. The ability of AP 100 to utilize multiple beams 1.18 can provide a dramatic increase in throughput and energy efficiency, when compared with omni-directional antenna configurations, which are conventionally utilized.

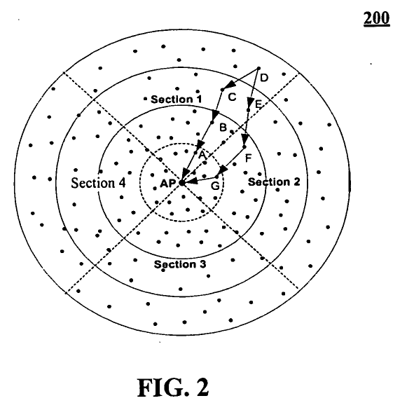

FIG. 2 is a diagram 200 illustrating a multi-beam access point being utilized within a multi-hop WLAN in accordance with an embodiment of the inventive arrangements disclosed herein. The Access point (AP) centrally located within diagram 200 can be AP 110 detailed in system 100. Diagram 200 emphasizes that the multi-beam access point and related techniques presented herein can be utilized in multi-hop environment as well as in single-hop environment. It should be appreciated that the utilization of a multi-beam access point within a multi-hop WLAN environment can alleviate congestion control and load balancing problems experienced within conventional multi-hop WLANs.

As shown in FIG. 2, each of the illustrated sections 1-4 can represent a beam of the multi-beam access point. For example, in one embodiment, the multi-beam access point can include at least four different directional antennas, each corresponding to a section. As shown in diagram 200, data can be exchanged from Node D to the access point (AP) along the path of Node D-Node C-Node B-Node A-AP.

It should be noted, that hops within the multi-hop WLAN can occur across beams or sections. For example, nodes D and E can be located within section 1 and nodes F and G can be located within section 2. Node D can convey data to the access point (AP) along the path of Node D-Node E-Node F-Node G-AP.

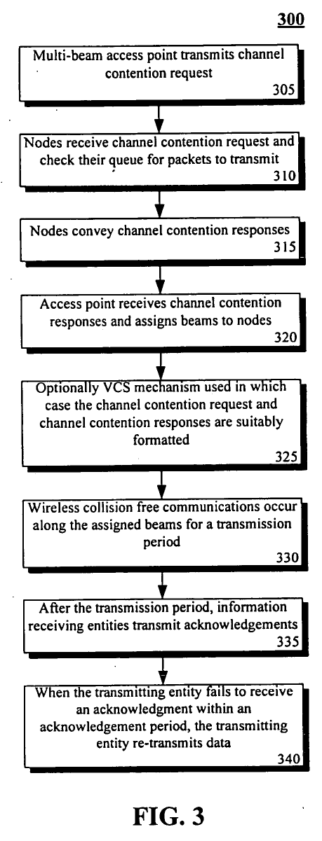

FIG. 3 is a flow chart of a method 300 for using a multi-beam access point in accordance with an embodiment of the inventive arrangements disclosed herein. Method 300 can be used in the context of any WLAN having a multi-beam access point, such as system 100.

Method 300 can begin in step 305, where a multi-beam access point transmits a channel contention request. A channel contention request is an access point initiated request that queries nodes regarding whether the nodes are ready to send and/or receive information. That is, a channel contention request can include a request indicating that data can be uplinked to the multi-beam access point (request-to-receive) and/or can include a request indicating that data is about to be downlinked from the multi-beam access point (request-to-send).

It should be appreciated that the channel contention request can be constructed to guarantee that the access points gains a higher priority to the access medium over nodes of the WLAN contending for the same channel. For example, the channel contention request can have a smaller inter-frame-space and contention window than an inter-frame space and contention window of request-to-send messages that are generated by WLAN nodes.

In step 310, each node can check their respective queues (assuming the channel contention request included a request-to-receive message) to determine if the node is ready to transmit packets. In step 315, the node can transmit a channel contention response, which can include a clear-to-send response or a node generated request-to-send response. In step 320, the access point can receive the channel contention responses and can responsively assign beams to nodes.

In optional step 325, a Virtual Carrier Sense (VCS) mechanism is contemplated as operating in conjunction with the mechanisms presented herein, meaning the channel contention request and channel contention responses can be suitably formatted for VCS techniques. That is, the channel contention requests and/or channel contention responses can include source, destination, and transmission duration information. Accordingly, all stations or nodes receiving the channel contention request or channel contention responses can set a VCS indicator or Network Allocation Vector (NAV) to the specified duration, and can use this information together with a Physical Carrier Sense when sensing the medium. The VCS mechanism can reduce the possibility of collisions occurring within beams because one of a receiver or transmitter is temporarily hidden from a transmitting node.

In step 330, wireless collision free communications can occur along the assigned beams for an established transmission period. Multiple packets can be transmitted by a transmitting node or by the multi-beam access point during this period so long as the combined time for transmitting the multiple packets is less than or equal to the transmission period. Transmissions can occur simultaneously or in parallel with one another along different beams. In step 335, after the transmission period, information receiving entities can transmit acknowledgments that the data has been received. These acknowledgements can also be simultaneously transmitted along different beams. In step 340, when the transmitting entity fails to receive an acknowledgement within an established acknowledgment period, the transmitting entity can re-transmit data.

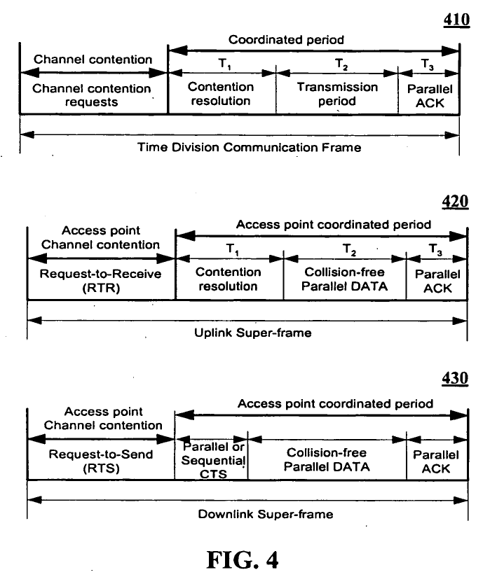

FIG. 4 is a diagram illustrating communication frames for conveying data within a wireless local area network in accordance with an embodiment of the inventive arrangements disclosed herein. Specifically, FIG. 4 includes time division communication frame 410, uplink super-frame 420, and downlink super-frame 430. Frames 410, 420, and 430 provide a MAC structure compatible with the inventive arrangements detailed for the system 100, diagram 200, and/or method 300.

Time division communication frame 410 includes a channel contention period and a coordinated period. Where the channel contention period is the time period in which channel contention requests are transmitted by an access point to nodes within range of the access point. The coordinated period can include a selection period (T₁) a transmission period (T₂) and an acknowledgement period (T₃).

The selection period (T₁) can also be referred to as the contention resolution period and is the period within which nodes compete for beams. Frame 410 is designed so that during the contention resolution period, multiple nodes “win.” Each “winning” node is assigned a collision free transmission path for the duration of the transmission period, where the transmission path is an assigned beam. Accordingly, the selection period is the period in which channel contention responses are received, the access point selects one or more nodes as “winning nodes”, and the winning nodes are assigned a beam.

Here, collision free means that the winning nodes will not collide with each other when they send data to the access point over an assigned beam, when they receive data from the access point over an assigned beam, and will not collide during the exchange of acknowledgment messages.

The transmission period (T₂) is the period during which the multi-beam access point and a plurality of nodes can use assigned beams to wirelessly exchange packetized digital data. These transmissions can occur simultaneously in parallel with each other over different beams. In one embodiment, different assigned beams can be simultaneously used to uplink data or downlink data. Multiple packets of information can be conveyed during the transmission period. A power control and/or auto rate scheme can be incorporated into hardware and software participating within the transmission period to further increase throughput and energy efficiency.

The acknowledgement period (T₃) can follow the transmission period. During the acknowledgement period a data receiving entity (which can be either a node or the multi-beam access point) can indicate that a successful transmission of data occurred. No acknowledgement can indicate that data was not successfully received. When an acknowledgement is not received within the acknowledgement period, the transmitting entity can re-transmit the data.

Notably, data re-transmissions will occur during a different transmission period and the transmitting entity may need to “win” the contention resolution process before being permitted to re-transmit the data. Accordingly, a re-transmission of data can occur after a brief delay. In one embodiment, if an acknowledgment of previously transmitted data is received during a re-transmission delay (before re-transmission occurs) the retransmission can be cancelled.

The uplink super-frame 420 is a special case of the time division communication frame 410 for uplinking information from one or more nodes to a multi-beam access point. According to the uplink super-frame 420, all nodes having uplink packets in a queue will not contend for a channel until the access point sends a ready-to-receive message, which occurs during the access point channel contention period. In other words, the uplink medium access is access-point driven. During the selection period (T₁) of the uplink super-frame 420 nodes can “win” beams through which the nodes can transmit collision free data during the transmission period (T₂). During the acknowledgment period (T₃) the access point can convey acknowledgment messages to nodes in parallel, each along a different beam.

The downlink super-frame 430 is a special case of the time division communication frame 410 for downlinking information from the multi-beam access point to one or more nodes. During the channel contention period, the access point can transmit a request-to-send message. During the selection period (T₁) the access point can receive clear-to-send messages from nodes, and assign nodes to available beams. Winning nodes receive data transmitted from the access point along assigned beams during the transmission period (T₂). After the transmission period the acknowledgment period (T₃) can begin, where the data receiving nodes can simultaneously convey acknowledgment messages back to the access point along assigned beams.

It should be appreciated that the implementation details shown for frames 410, 420, and 430 are configured to ensure desired transmission behavior and compatibility with hardware and software utilized within the network. For example, the frame 410, 420, and 430 can be adjusted for compliance with 802.11 based protocols.

The times established for the specified periods can also be adjusted to ensure that the access point favorably competes with other nodes of a given WLAN in which the frames 410, 420, and/or 420 are utilized. For example, the channel contention request can have a smaller inter-frame-space and contention window than that inter-frame space and contention window of request-to-send messages that are generated by other nodes of said WLAN.

In another example, the time periods of frames 410, 420, and 430 can be adjusted for a multi-hop WLAN to ensure that adequate time is provided for the channel contention period and the acknowledgment period to ensure distant nodes distant from the access point or otherwise subject to multiple hops are given adequate response time.

The present invention may be realized in hardware, software, or a combination of hardware and software. The present invention may be realized in a centralized fashion in one computer system or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A method for conveying digitally encoded data within a Wireless Local Area Network (WLAN) using a contention based Media Access Control (MAC) protocol comprising the steps of:
a multi-beam access point transmitting a channel contention request;
responsively receiving channel contention responses;
determining a set of nodes based upon the channel contention responses;
assigning one beam of a plurality of beams associated with the multi-beam access point to each node of the determined set;
using the assigned beams to simultaneously communicate between the determined set of nodes and the multi-beam access point in a collision free fashion.

2. The method of claim 1, wherein each channel contention response originates from a node of said WLAN, wherein the determined set of nodes is a subset of and includes fewer nodes than a set of nodes that originated said channel contention responses, wherein the communications along the assigned beams occur at the MAC layer of the WLAN and occur by conveying packetized digital data along the assigned beams.

3. The method of claim 2, wherein said channel contention request is a request-to-receive message and wherein each channel contention response indicates that the originating node has packages of data that are to be uplinked to the multi-beam access point.

4. The method of claim 1, wherein at least one of the nodes in the determined set of nodes wirelessly communicates with said multi-beam access point using IEEE 802.11 compliant hardware in a manner conforming to IEEE 802.11 protocol standards.

5. The method of claim 1, wherein said channel contention request comprises a request-to-send message and wherein each channel contention response comprises a clear-to-send response.

6. The method of claim 1, wherein at one time interval said plurality of beams are each dedictated to either uplink data to the multi-beam access point or to downlink data from the multi-beam access point.

7. The method of claim 1, wherein said method utilizes a Virtual Carrier Sense (VCS) mechanism, wherein said channel contention request and said channel contention responses include data specifying a data transmission source, a data transmission destination, and a transmission duration.

8. The method of claim 1, wherein said channel contention request has a smaller inter-frame-space and contention window than that inter-frame space and contention window of request-to-send messages that are generated by other nodes of said WLAN.

9. The method of claim 1, wherein a fixed contention period is defined within which channel contention responses are received and wherein said multi-beam access point determines said set of nodes and assigns beams to each.

10. The method of claim 1, wherein a fixed transmission period is defined within which data is exchanged between the multi-beam access point and the nodes along the assigned beams, wherein each node is configured to transmit a plurality of packets during said transmission period so long as a time required for transmitting said plurality of packets does not exceed said transmission period.

11. The method of claim 1, wherein a plurality of acknowledgements are simultaneously conveyed between the multi-beam access point and the nodes, each acknowledgment being conveyed along an assigned beam.

12. The method of claim 11, wherein a fixed acknowledgement period is defined within which acknowledgements are conveyed between the multi-beam access point and the nodes, wherein when no acknowledgement is received by a data transmitting entity during said acknowledgment period, said data transmitting entity responsively re-transmits corresponding data.

13. The method of claim 1, wherein said WLAN is a multi-hop WLAN.

14. A machine readable storage, having stored thereon a computer program having a plurality of code sections executable by a machine for causing the machine to perform the steps of:
a multi-beam access point of said WLAN transmitting a channel contention request;
the multi-beam access point receiving a plurality of channel contention responses in response to said channel contention request, each channel contention response originating from a node of said WLAN;
said multi-beam access point determining a set of said nodes based upon the channel contention responses, wherein said determined set is a subset of the nodes that originated said channel contention responses;
said multi-beam access point assigning each node of said determined set one beam of said multi-beam access point; and
each node of said determined set utilizing said assigned beam to wireless communicate with said multi-beam access point by exchanging packetized digital data, wherein a plurality of nodes simultaneously communicate with said multi-beam access point, and wherein each node communicates in a collision-free fashion using the assigned beam.

15. A Wireless Local Area Network (WLAN) comprising:
a plurality of computing stations communicatively linked via a contention-based, collision free MAC protocol; and
a multi-beam access point configured to assign a plurality of beams to particular ones of said computing stations, wherein said computing stations wireless communicate with said multi-beam access point via assigned beams, wherein at least a portion of said computing stations use IEEE 802.11 compliant hardware to communicate with the multi-beam access point.

16. The WLAN of claim 15,. wherein said multi-beam access point comprises a plurality of transceivers, each transceiver associated with one of said beams, wherein a plurality of computing stations simultaneously communicate with the multi-beam access point via different ones of the beams.

17. The WLAN of claim 16, wherein at one time interval said plurality of beams are each dedictated to either uplink data to the multi-beam access point or to downlink data from the multi-beam access point.

18. The WLAN of claim 15, wherein said WLAN is a multi-hop WLAN.

19. A multi-beam access point comprising:
a multi-beam smart antenna configured to capture and radiate radio frequency energy within a frequency range comprising of at least one of a 2.4 GHz to 2.4835 GHz frequency range, and a 5.15 GHz to 5.825 GHz frequency range,
at least one transceiver communicatively linked to said multi-beam smart antenna, wherein said multi-beam access point is configured to initiate wireless data conveyances with nodes by transmitting channel contention requests and assigning beams to nodes based upon channel contention responses, wherein nodes wirelessly exchange data with said multi-beam access point via the assigned beams, and wherein said multi-beam access point is configured to operate within an ad hoc WLAN using a contention-based collision free MAC protocol.

20. The multi-beam access point of claim 19, wherein said channel contention requests have a smaller inter-frame-space and contention window than an inter-frame space and contention window of request-to-send messages that are generated by said nodes.

21. The multi-beam access point of claim 19, wherein at least one of the nodes wirelessly communicates with said multi-beam access point using IEEE 802.11 compliant hardware in a manner conforming to IEEE 802.11 protocol standards.

22. The multi-beam access point of claim 19, wherein said multi-beam antenna comprises a directional antenna.

23. The multi-beam access point of claim 22, wherein said directional antenna is a multi-beam directional antenna, and wherein said at least one transceiver comprises a plurality of transceivers, each corresponding to a particular beam of said multi-beam directional antenna.

24. The multi-beam access point of claim 19, wherein said multi-beam smart antenna is an adaptive array antenna.

25. A time division communication frame for digitally conveying data within a WLAN comprising:
a channel contention period wherein channel contention requests are transmitted;
a selection period following said channel contention period wherein channel contention responses associated with nodes are received and wherein communication beams are assigned to nodes;
a transmission period following said contention period wherein a plurality of nodes use assigned beams to wirelessly exchange packetized digital data, wherein said nodes simultaneously exchange data in parallel over different beams; and
an acknowledgement period following said transmission period wherein acknowledgements of. successful transmission of data are conveyed in parallel over different beams, and wherein said communication frame is used to convey information between nodes in a contention based, collision free Media Access Control (MAC) layer of a WLAN.

26. The communication frame of claim 25, wherein said communication frame is an uplink superframe, wherein said channel contention requests include request-to-receive messages, and wherein said channel contention responses corresponding to said request-to-receive messages each indicate that an originating node has packages of data that are to be uplinked.

27. The communication frame of claim 25, wherein said communication frame is a downlink superframe wherein said channel contention requests include request-to-send messages, and wherein said channel contention responses include clear-to-send responses.

28. The communication frame of claim 25, wherein said communication frame is used to enable a multi-beam access control point to simultaneously communicate with a plurality of nodes within said WLAN over different beams defined by said multi-beam access control point.

29. The communication frame of claim 28, wherein at least one of said nodes wirelessly communicates with said multi-beam access point using IEEE 802.11 compliant hardware in a manner conforming to IEEE 802.11 protocol standards.
